(19) United States
(12) Patent Application Publication
(10) Pub. No.: US 2026/0233606 A1
(43) Pub. Date: Aug. 13, 2026

(54) System and Method of Audibly Assisting a Driver of a Commercial Vehicle

(71) Applicant: Wyse Software LLC, Kennett Square, PA (US)

(72) Inventors: Ray Patterson, Kennett Square, PA (US); Andrew Oleson, Garland, TX (US)

(21) Appl. No.: 19/534,483

(22) Filed: Feb. 9, 2026

Related U.S. Application Data
(60) Provisional application No. 63/755,839, filed on Feb. 7, 2025.

(51) Int. Cl. B60K 35/26; B60K 35/10; G10L 15/26

(52) U.S. Cl. CPC B60K 35/26; B60K 35/10; G10L 15/26; B60K 2360/148

(57) ABSTRACT

A system and method of audibly assisting a driver of a commercial vehicle is provided to enhance driver confidence, ensure timely deliveries, and boost overall productivity and communication for a commercial driver. An audible activation cue is received with a portable Personal Computing (PC) device. A speech-to-text-conversion engine is then executed with the portable PC device by inputting the audible activation cue into the speech-to-text-conversion engine. The speech-to-text-conversion engine is further executed with the portable PC device by outputting a cue transcription of the audible activation cue with the speech-to-text-conversion engine. The cue transcription is then compared to the textual activation cue of each software feature with the portable PC device in order to identify a matching software feature from the plurality of software features. Finally, the matching software feature is executed with the portable PC device, if the matching software feature is identified amongst the plurality of software features.

The current application claims a priority to the U.S. provisional patent application serial number 63/755,839 filed on February 7, 2025. The current application is filed on February 9, 2026, while February 7, 2026 was on a weekend.

### FIELD OF THE INVENTION

The present invention generally relates to voice assistants and fleet management and tracking systems. More specifically, the present invention provides a personal voice assistant for commercial and service industry drivers.

### BACKGROUND OF THE INVENTION

According to a recent survey from Drive My Way, only 51% of Commercial Driver’s License (CDL) drivers were happy on the job in the years 2022 and 2023, down from 54% in 2019. The survey found that among the top concerns for drivers were compensation and communication. Truck drivers are important to the economy, moving goods and keeping industries like construction, healthcare, and retail functioning. Potential solutions that can resolve these problems include, but are not limited to, offering competitive pay and benefits for drivers, providing good support and communication, providing regular schedules and home time, providing comfortable and reliable trucks, providing beneficial equipment, rewarding good work, and showing care to drivers.

Moreover, CDL drivers experience greater risks while driving than normal drivers, such as facing greater driver distractions. The Federal Motor Carrier Safety Administration (FMCSA) defines driver distraction as “the diversion of attention from activities critical for safe driving to a competing activity.” For example, driver distractions includes, but is not limited to, using electronic devices (e.g., texting), reaching for objects (e.g., water bottle or snack), looking outside (e.g., looking at people on the street, rubbernecking, or reading a billboard), eating and drinking, etc. Further, driver distractions include cognitive distractions such as thinking about a conversation, daydreaming, or feeling drowsy. Other cognitive distractions include using maps while driving to navigate to the desired destination.

According to recent data, 71% of commercial accidents are caused by distractions. The number of accidents per year can result in great operational costs for the companies if the drivers are found liable. For example, 5,000 fatal commercial truck accidents per year at an average of $10 million per verdict costs above $50 billion per year for the company, not including 117 thousand injuries per year. So, novel solutions are necessary to improve the working conditions of CDL drivers and reduce the operational costs of the company.

Therefore, the present invention provides a system and method of audibly assisting a driver of a commercial vehicle. The present invention functions at a higher level and integrates effortlessly with in-cab telematics technology (i.e., electronic logging devices). This allows the present invention to enhance driver productivity, ensure the safety of both drivers and the public, and facilitate improved communication between drivers and dispatch. Further, the present invention can implement Artificial Intelligence (AI) and machine learning to further enhance the overall functionality of the present invention. Additional features and benefits of the present invention are further discussed in the sections below.

### SUMMARY OF THE INVENTION

The present invention provides a system and method of audibly assisting a driver of a commercial vehicle. The present invention is designed to serve as a commercial driver’s personal assistant to optimize driver Electronic Logging Device (ELD) use, productivity, and safety. The present invention enables the hands-free use of the ELD to reduce in-cab distraction and improves driver workflow accuracy. By implementing the present invention into the ELD, the present invention can provide various benefits to Commercial Driver’s License (CDL) drivers. Key benefits provided to CDL drivers include, but are not limited to:

Reduced driver distraction: The present invention allows drivers to access information, adjust settings, make calls, and send messages using voice commands which significantly decreasing the risk of accidents due to distractions.

Enhanced safety: The present invention minimizes manual interactions with the ELD to promote safer driving practices and help drivers stay alert by providing critical information through voice prompts.

Improved operational efficiency: The present invention streamlines tasks like navigation, checking delivery schedules, logging hours of service, and accessing vehicle diagnostics which leads to faster and more efficient operations.

Compliance management: The present invention can remind drivers of important compliance requirements, such as hours-of-service limits, and can capture necessary documentation through voice commands.

Increased driver satisfaction: The present invention enables hands-free interaction and simplifies complex tasks to improve driver experience and satisfaction.

Hands-free control of vehicle functions: The present invention allows drivers to use voice commands to adjust and manage entertainment systems and control other in-vehicle features.

Better communication with dispatchers: The present invention facilitates real-time communication with dispatchers, allowing for faster updates on delivery status, route changes, and any issues that may arise.

Thus, the present invention facilitates the automation of any delivery process in the transportation and service sectors which is an essential strategy to improve fleet safety and driver productivity. The present invention addresses major challenges including, but not limited to, reducing costly nuclear verdicts, improving driver morale, improving driver productivity, and improving driver turnover. The present invention helps to prevent the slim profit margins that have led to the unfortunate consolidation of transportation companies.

### BRIEF DESCRIPTION OF THE DRAWINGS

FIG. 1 is a box diagram showing the portable PC device of the system of the present invention.

FIG. 2 is a box diagram showing the overall system of the present invention.

FIG. 3 is a flowchart showing the overall process of the method of the present invention.

FIG. 4 is a flowchart showing the subprocess of login the driver into the ELD system.

FIG. 5 is a flowchart showing the subprocess of verifying the driver-identification information while logging in.

FIG. 6 is a flowchart showing the subprocess of login the driver out of the ELD system.

FIG. 7 is a flowchart showing the subprocess of verifying the driver-identification information while logging out.

FIG. 8 is a flowchart showing the subprocess of responding to an audible inquiry of the driver’s total drive time.

FIG. 9 is a flowchart showing the subprocess of responding to an audible inquiry of the driver’s remaining drive time.

FIG. 10 is a flowchart showing the subprocess of facilitating the relaying a message from the driver.

FIG. 11 is a flowchart showing the subprocess of establishing a level of urgency for the driver message.

FIG. 12 is a flowchart showing the subprocess of outputting a dispatch message to the driver.

FIG. 13 is a flowchart showing the subprocess of assisting the preparation of a DVIR before or after a trip.

FIG. 14 is a flowchart showing the subprocess of attaching a picture or video to the vehicle-inspection note.

FIG. 15 is a flowchart showing the subprocess of adding the current time and location to the DVIR.

FIG. 16 is a flowchart showing the subprocess of performing the vehicle inspection using the mobile PC device.

FIG. 17 is a flowchart showing the subprocess of appending a picture or video to the vehicle inspection report using the mobile PC device.

FIG. 18 is a flowchart showing the subprocess of adding the current time and location to the DVIR.

### DETAILED DESCRIPTION OF THE INVENTION

All illustrations of the drawings are for the purpose of describing selected versions of the present invention and are not intended to limit the scope of the present invention.

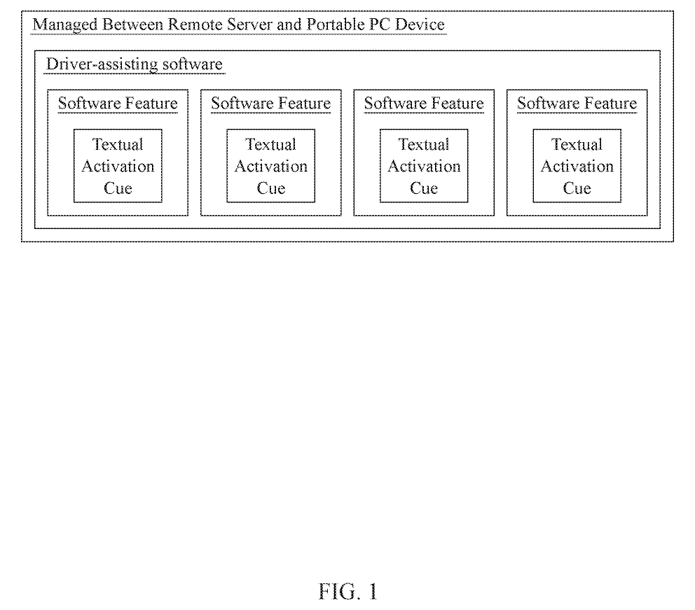

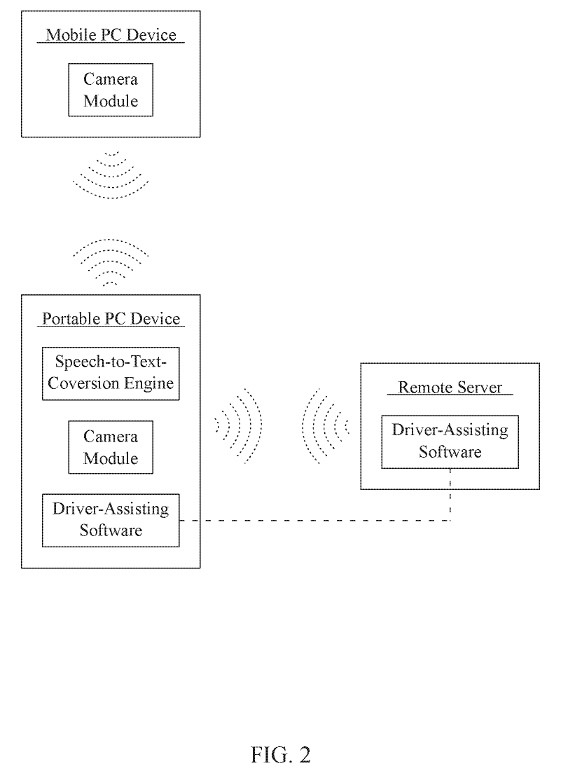

The present invention provides a system and method of audibly assisting a driver of a commercial vehicle. The present invention is preferably implemented as a voice assistant for commercial drivers in the trucking industry. However, the present invention can be configured to serve other drivers in different industries. Further, the voice assistant of the present invention enhances drivers’ confidence, ensures timely deliveries, and boosts overall productivity and communication for a fleet of commercial drivers. As can be seen in FIGS. 1 and 2, the system of the present invention includes at least one driver-assisting software managed between at least one remote server and a portable personal computing (PC) device (Step A). The driver-assisting software of the present invention enables the implementation of the voice assistant on the portable PC device. The portable PC device corresponds to a computing device that is utilized by the driver of the corresponding commercial truck. For example, the portable PC device can be a tablet computer or laptop that is equipped in the truck’s cabin.

Further, the portable PC device can be provided by the company and can be equipped with the necessary software that allows the company to track and provide the necessary data for the driver. For example, the portable PC device can be an Electronic Logging Device (ELD) that allows the company to accurately track, manage, and share data to the driver during driving and off-duty time. As can be seen in FIGS. 1 and 2, the remote server and the portable PC device are communicably coupled to each other to enable the wireless transmission of the appropriate data. In addition, the driver-assisting software includes a plurality of software features corresponding to different voice-activated functionalities enabled by the present invention. Thus, each software feature includes a textual activation cue corresponding to a predetermined cue that activates the corresponding feature when the driver audibly inputs a command.

Commercial drivers are mandated by law to keep logs of different aspects including, but not limited to, On-Duty hours, Drive Time, Sleeper Berth hours, and Off-Duty hours. This typically necessitates the driver to interact with a computing device on the corresponding truck. Given that many drivers lack the technical proficiency to engage with such technology, the system of the present invention creates a user-friendly environment through voice-activated commands to support the driver. By automating various manual tasks via voice instructions, the driver can simply communicate with the portable PC device. This eliminates the need for the driver to navigate the user interface on the computing devices and reduces the risk of input errors when relaying trip-related information back to the company. The system of the present invention streamlines the interaction between the driver and the essential technology in the truck to significantly diminish in-cab distractions.

Further, the system of the present invention is seamlessly integrated with the portable PC device, which can be the existing ELD in the truck. This way, when the driver audibly requests a task from the plurality of software features, the system would automatically provide the necessary information or confirmation corresponding to the requested task, thus eliminating the need for the driver to navigate a cumbersome manual process. As can be seen in FIGS. 1 and 2, the system of the present invention further includes a speech-to-text-conversion engine managed by the portable PC device (Step B). The speech-to-text-conversion engine allows the driver’s voice command to be converted into a machine-readable command that the portable PC device can utilize to perform the corresponding task.

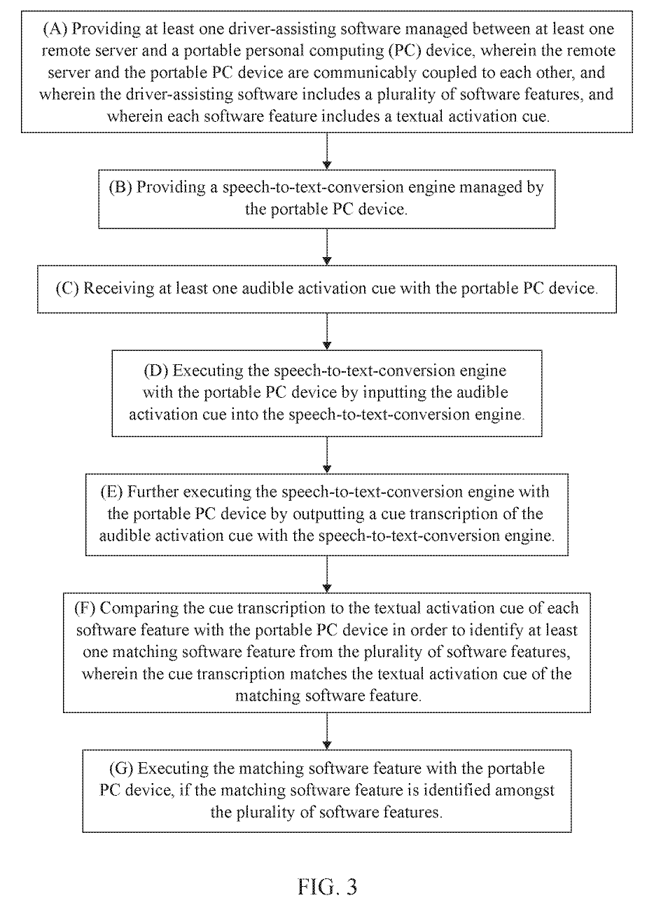

As previously mentioned, the system of the present invention aims to enhance driver safety and productivity by facilitating the implementation of voice-activated interaction with the portable PC device. As can be seen in FIG. 3, the overall process of the method of the present invention begins with receiving at least one audible activation cue with the portable PC device (Step C). Once the portable PC device is activated, the driver only needs to speak the appropriate activation cue corresponding to the desired task to be performed. For example, at the start of each day, the driver simply can say, "Charlie, log me in," after which the system verifies the driver's name and ID number. The name “Charlie” corresponds to a possible name of the voice assistant of the present invention. In addition, the system ensures compliance with government regulations and company safety protocols, such as monitoring for speeding, alerting drivers to adverse weather conditions, providing job-related reminders, and facilitating communication with the office.

As can be seen in FIG. 3, once the portable PC device detects the audible activation cue, the speech-to-text-conversion engine is executed with the portable PC device by inputting the audible activation cue into the speech-to-text-conversion engine (Step D). Using the portable PC device’s microphone, the driver’s audible activation cue is picked up and recorded by the portable PC device for processing. Further, the speech-to-text-conversion engine is executed with the portable PC device by outputting a cue transcription of the audible activation cue with the speech-to-text-conversion engine (Step E). In other words, once the audible activation cue is processed by the portable PC device and fed into the speech-to-text-conversion engine, the audible activation cue is converted into the corresponding cue transcription in a machine-readable format that the portable PC device can utilize. The overall format of the cue transcription depends on the technological capabilities of the portable PC device.

As can be seen in FIG. 3, once the cue transcription is generated, the cue transcription is compared to the textual activation cue of each software feature with the portable PC device in order to identify at least one matching software feature from the plurality of software features (Step F). In the preferred embodiment, each software feature corresponds to a specific software feature so that the appropriate software feature is executed once the driver’s command is detected. Further, the matching software feature is identified when the cue transcription matches the textual activation cue of the matching software feature. This way, the correct software feature is executed when the driver makes an audible request. Finally, the matching software feature is executed with the portable PC device (Step G), if the matching software feature is identified amongst the plurality of software features. Depending on the type of software feature, different information may be outputted or captured by the portable PC device. In other embodiments, the overall process of the method of the present invention can be modified to implement other software features.

As previously discussed, one of the software features corresponds to the automatic login of the driver before starting the trip. As can be seen in FIGS. 1 and 2, the system includes a driver-login feature as at least one feature of the plurality of software features, which logs the driver into the ELD system. In addition, the driver-login feature includes a driver voiceprint which corresponds to a digital file that helps identify the driver’s voice. The driver voiceprint is generated prior to the driver beginning the trip. Further, the driver voiceprint can be locally stored on the portable PC device or on the remote server if the portable PC device can remain connected to the remote server during the duration of the driver’s trip.

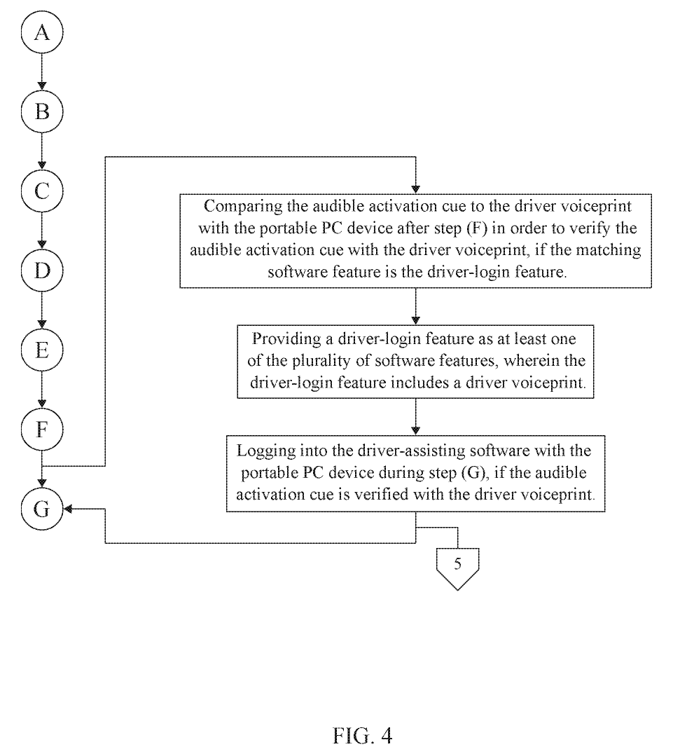

As can be seen in FIG. 4, the subprocess of login the driver into the ELD system includes the steps of comparing the audible activation cue to the driver voiceprint with the portable PC device after Step F in order to verify the audible activation cue with the driver voiceprint, if the matching software feature is the driver-login feature. For example, the audible activation cue can be, “Charlie, log me in to start my day,” which would trigger the driver-login feature. The driver voiceprint is important since the system needs to verify that the authorized driver is the one logging into the ELD system. Then, the driver-assisting software is logged into with the portable PC device during Step G, if the audible activation cue is verified with the driver voiceprint. This way, the driver is given access to all the software features of the ELD system through the portable PC device.

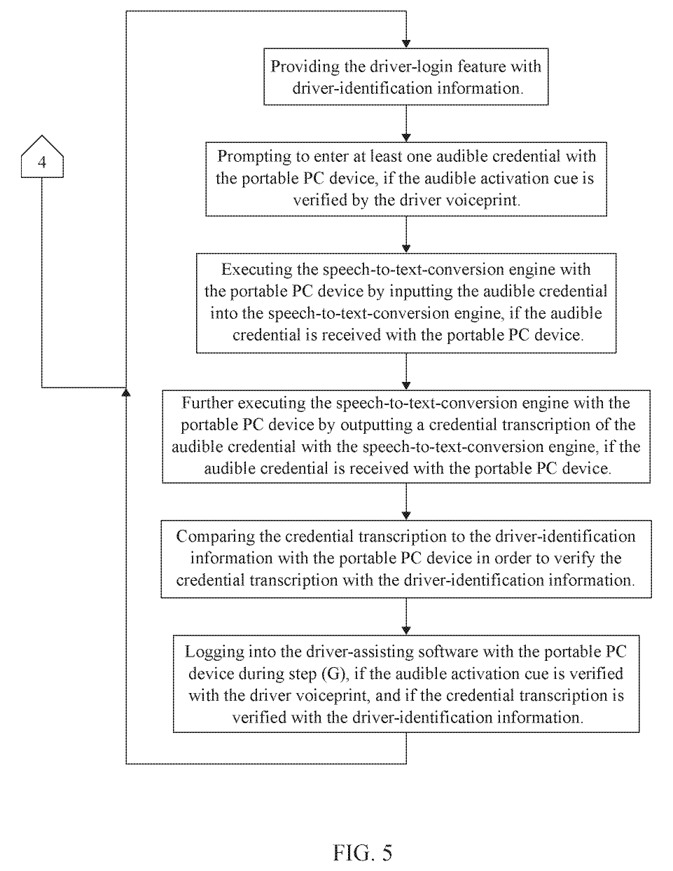

In some embodiments, additional driver verification can be implemented to identify the driver’s identity. As can be seen in FIGS. 1 and 2, the driver-login feature can be provided with driver-identification information corresponding to driver information that can be used to verify the driver’s identity. For example, the driver-identification information can include, but is not limited to, the driver’s name, the driver’s company identification (ID), etc. As can be seen in FIG. 5, the subprocess of verifying the driver-identification information while logging in includes the steps of prompting to enter at least one audible credential with the portable PC device, if the audible activation cue is verified by the driver voiceprint. For example, the driver’s name and company ID can be locally stored in the portable PC device and outputted using the device’s speaker for the driver to confirm. The portable PC device can output, “John Smith, driver 125634 confirmed on duty, is this correct?” which prompts the driver to confirm by giving audible credentials.

As can be seen in FIG. 5, once the driver provides audible credentials, the speech-to-text-conversion engine is executed with the portable PC device by inputting the audible credential into the speech-to-text-conversion engine, if the audible credential is received with the portable PC device. The audible credential is fed into the speech-to-text-conversion engine to generate a machine-readable file that the portable PC device can use. Then, the speech-to-text-conversion engine is executed with the portable PC device by outputting a credential transcription of the audible credential with the speech-to-text-conversion engine, if the audible credential is received with the portable PC device. The credential transcription allows the extraction of the necessary data that can be used to verify driver-identification information such as the driver’s name. Then, the credential transcription is compared to the driver-identification information with the portable PC device in order to verify the credential transcription with the driver-identification information. This allows the verify the provided audible credential with the stored driver-identification information to help verify the driver’s identity. Finally, the driver-assisting software is logged into with the portable PC device during Step G, if the audible activation cue is verified with the driver voiceprint, and if the credential transcription is verified with the driver-identification information. Thus, the system ensures that only the authorized user can log into the ELD system and access the software features on the portable PC device.

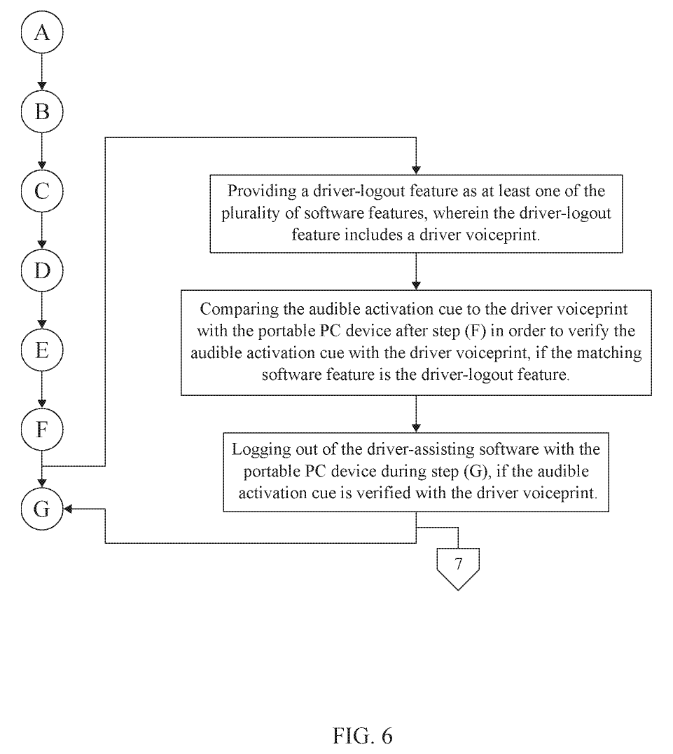

Similar to the driver login subprocess, the system also allows the user to log out of the ELD system using a voice command. As can be seen in FIGS. 1 and 2, the system may further include a driver-logout feature as at least one feature of the plurality of software features. The driver-logout feature also utilizes the driver voiceprint for driver verification purposes. As can be seen in FIG. 6, the subprocess of login the driver out of the ELD system includes the steps of comparing the audible activation cue to the driver voiceprint with the portable PC device after Step F in order to verify the audible activation cue with the driver voiceprint, if the matching software feature is the driver-logout feature. For example, the audible activation cue can be, “Charlie, log me out for the day,” which would trigger the driver-logout feature. Then, the driver-assisting software is logged out with the portable PC device during Step G, if the audible activation cue is verified with the driver voiceprint. This way, the driver can safely and securely log out of the ELD system without directly interacting with the portable PC device while driving.

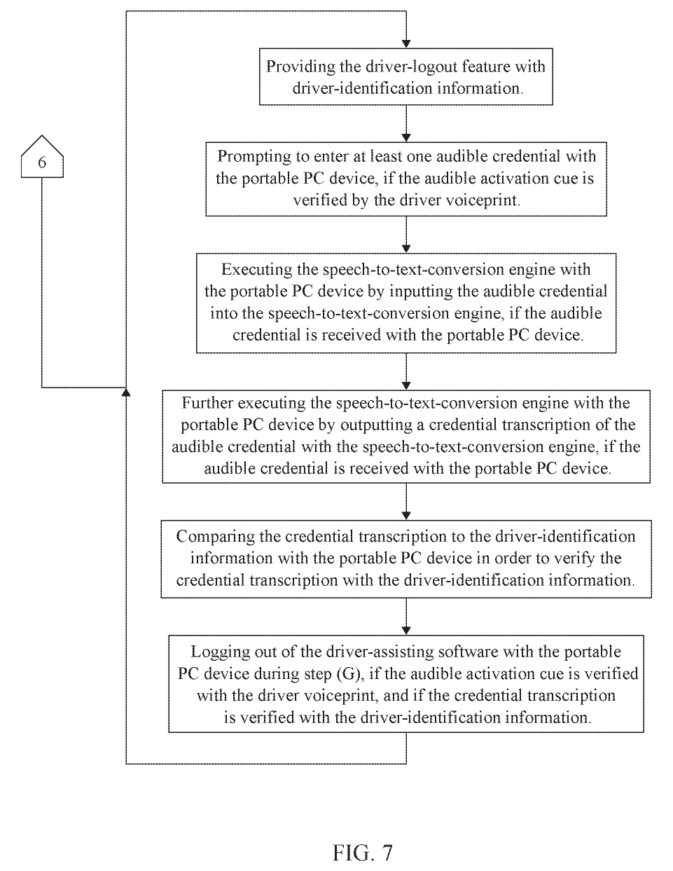

In some embodiments, additional driver verification can be implemented to ensure that the person speaking is the authorized driver who can log out of the ELD system. As can be seen in FIGS. 1 and 2, the driver-logout feature also utilizes the driver-identification information that the driver-login feature does. As can be seen in FIG. 7, the subprocess of verifying the driver-identification information while logging out includes the steps of prompting to enter at least one audible credential with the portable PC device, if the audible activation cue is verified by the driver voiceprint. Like before, the driver’s name and company ID can be locally stored in the portable PC device and outputted using the device’s speaker for the driver to confirm. The portable PC device can output, “John Smith, driver 125634 confirmed off duty, is this correct?” which prompts the driver to confirm by giving audible credentials.

As can be seen in FIG. 7, once the driver provides audible credentials, the speech-to-text-conversion engine is executed with the portable PC device by inputting the audible credential into the speech-to-text-conversion engine, if the audible credential is received with the portable PC device. Like before, the audible credential is fed into the speech-to-text-conversion engine to generate a machine-readable file that the portable PC device can use. Then, the speech-to-text-conversion engine is executed with the portable PC device by outputting a credential transcription of the audible credential with the speech-to-text-conversion engine, if the audible credential is received with the portable PC device. The credential transcription allows the extraction of the necessary data that can be used to verify driver-identification information. Then, the credential transcription is compared to the driver-identification information with the portable PC device in order to verify the credential transcription with the driver-identification information. This allows the verification of the driver’s identity while logging the driver out of the ELD system. Finally, the driver-assisting software is logged out with the portable PC device during Step G, if the audible activation cue is verified with the driver voiceprint, and if the credential transcription is verified with the driver-identification information. Thus, the system ensures that only the authorized user can log out of the ELD system. In other embodiments, the log in and log out subprocesses can be modified to implement other verification procedures.

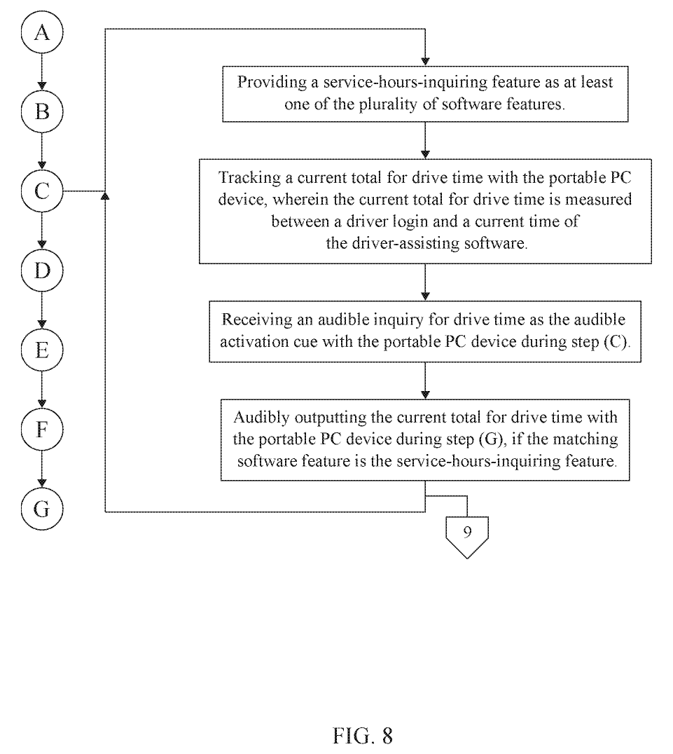

During the trip, the driver can be forced to perform different administrative tasks to comply with governmental regulations or company policies. For example, the driver can be forced to drive a limited number of hours during a specific period. As can be seen in FIGS. 1 and 2, the system of the present invention may further include a service-hours-inquiring feature as at least one feature of the plurality of software features. As can be seen in FIG. 8, the subprocess of responding to an audible inquiry of the driver’s total drive time includes the steps of tracking a current total for drive time with the portable PC device, wherein the current total for drive time is measured between a driver login and a current time of the driver-assisting software. The drive time can be calculated using different methodologies depending on the technology available on the corresponding truck and the portable PC device. Regardless, the current drive time can be accessed from the portable PC device when inquired. Then, when the user asks about the current drive time, an audible inquiry for drive time is received as the audible activation cue with the portable PC device during Step C. For example, the audible inquiry for drive time can be, “Charlie, what is the current drive time on my logs?” Further, the current total for drive time is audibly output with the portable PC device during Step G, if the matching software feature is the service-hours-inquiring feature. This way, the driver can check the current drive time total without manually interacting with the portable PC device while driving.

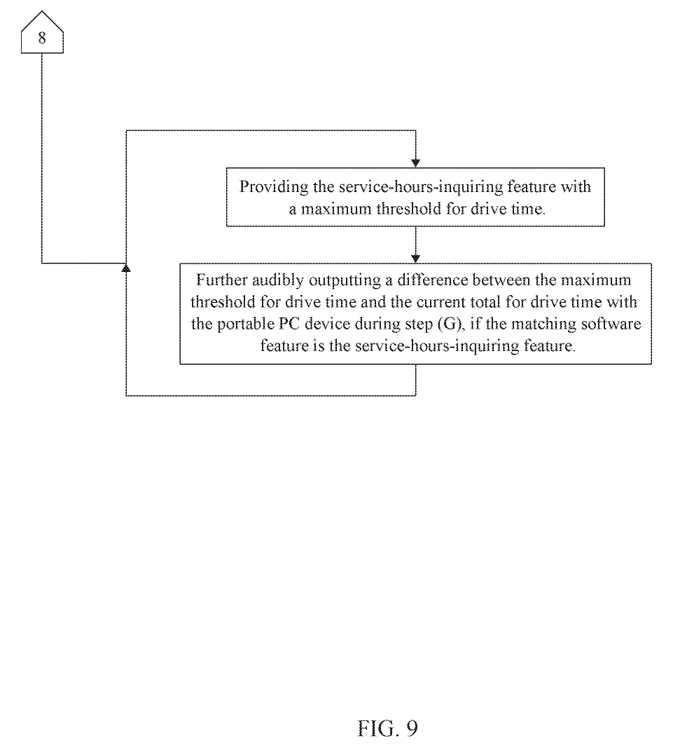

In addition to the current drive time total, the driver can ask for the remaining drive time available for the driver’s on-duty time. As can be seen in FIGS. 1 and 2, the service-hours-inquiring feature can be provided with a maximum threshold for drive time corresponding to the limited amount of time the driver is allowed to drive during a specific period. As can be seen in FIG. 9, the subprocess of responding to an audible inquiry of the driver’s remaining drive time includes the step of further audibly outputting a difference between the maximum threshold for drive time and the current total for drive time with the portable PC device during Step G, if the matching software feature is the service-hours-inquiring feature. Checking which inquiring feature ensures that the correct drive time information is provided to the driver. The audible inquiry can be, “Charlie, how many hours of drive time remain on my logs?” and the audible response can be, “John Smith currently has 2 hours of drive time remaining and 3 hours of on-duty time.” In other embodiments, the system can allow the user to set up reminders or alarms for the user to be alerted when the drive time total has reached a predetermined threshold.

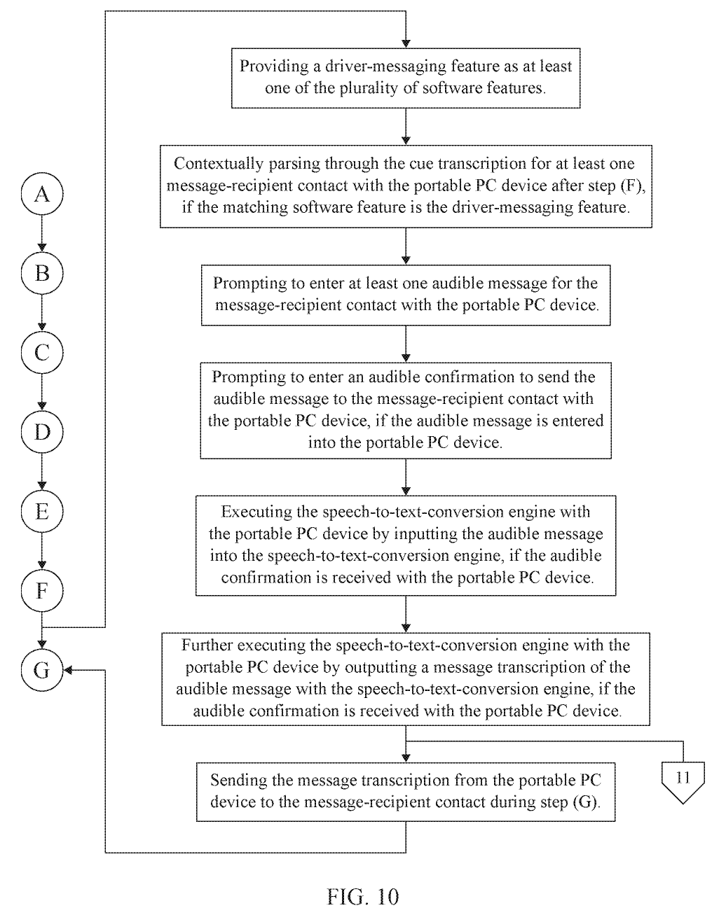

To prevent distractions to the driver during the trip, the system can allow the driver to message the company whenever necessary. For example, after inquiring about the remaining drive time, the driver can message dispatch to inform dispatch that the driver may run out of drive time before arriving to the destination. As can be seen in FIGS. 1 and 2, the system may further include a driver-messaging feature as at least one feature of the plurality of software features. The driver-messaging feature mainly allows the driver to message dispatch or other authorized users. However, the driver-messaging feature may allow the driver to message other drivers if company policies permit so. As can be seen in FIG. 10, the subprocess of facilitating the relaying a message from the driver includes the steps of contextually parsing through the cue transcription for at least one message-recipient contact with the portable PC device after Step F, if the matching software feature is the driver-messaging feature. This allows the system to determine that the driver wants to send a message. For example, the cue transcription can be, “Charlie, send a message to dispatch,” which triggers the driver-messaging feature. As previously discussed, the message-recipient contact is preferably the dispatch contact information to allow the driver to only contact dispatch. However, other recipients can be allowed to be messaged by the driver, so the portable PC device may store the contact information of other users.

As can be seen in FIG. 10, once the system determines that the driver is trying to send a message, the driver is prompted to enter at least one audible message for the message-recipient contact with the portable PC device. For example, the portable PC device can audibly output a confirmation message and asks for the message to be sent. Then, driver is prompted to enter an audible confirmation to send the audible message to the message-recipient contact with the portable PC device, if the audible message is entered into the portable PC device. For example, after driver speaks the message, the portable PC device records the message and confirms the message with the driver. Afterwards, the speech-to-text-conversion engine is executed with the portable PC device by inputting the audible message into the speech-to-text-conversion engine, if the audible confirmation is received with the portable PC device. The audible message is transcribed in order to extract the contents of the message from the driver. Further, the speech-to-text-conversion engine is executed with the portable PC device by outputting a message transcription of the audible message with the speech-to-text-conversion engine, if the audible confirmation is received with the portable PC device. As the content of the message is extracted from the message transcription, the portable PC device can compile the message to be delivered to the message-recipient contact. Finally, the message transcription is sent from the portable PC device to the message-recipient contact during Step G.

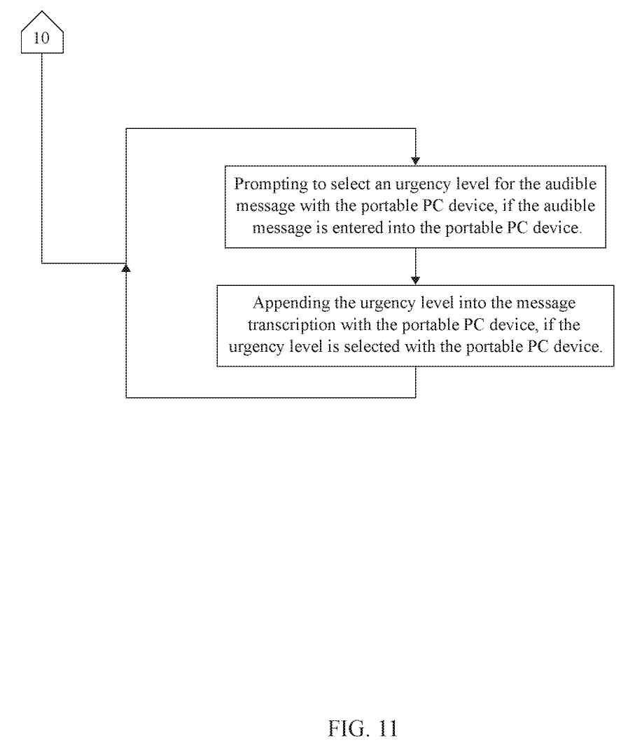

In addition to facilitating the delivery of the message from the driver, the system of the present invention can further enable the driver to set an urgency level for the message. By establishing a level of urgency, the recipient can pay greater attention to the message as necessary. As can be seen in FIG. 11, the subprocess of establishing a level of urgency for the driver message includes the steps of prompting the driver to select an urgency level for the audible message with the portable PC device, if the audible message is entered into the portable PC device. The portable PC device can output, “would you like me to send the message as urgent, or send message now?” This enables the driver to choose whether the message is urgent or not. Additional levels of urgency can be established as necessary. Once the urgency level has been selected, the urgency level is appended into the message transcription with the portable PC device, if the urgency level is selected with the portable PC device. This allows the message to be output to the recipient with the appropriate notification of urgency using the recipient’s device technological capabilities.

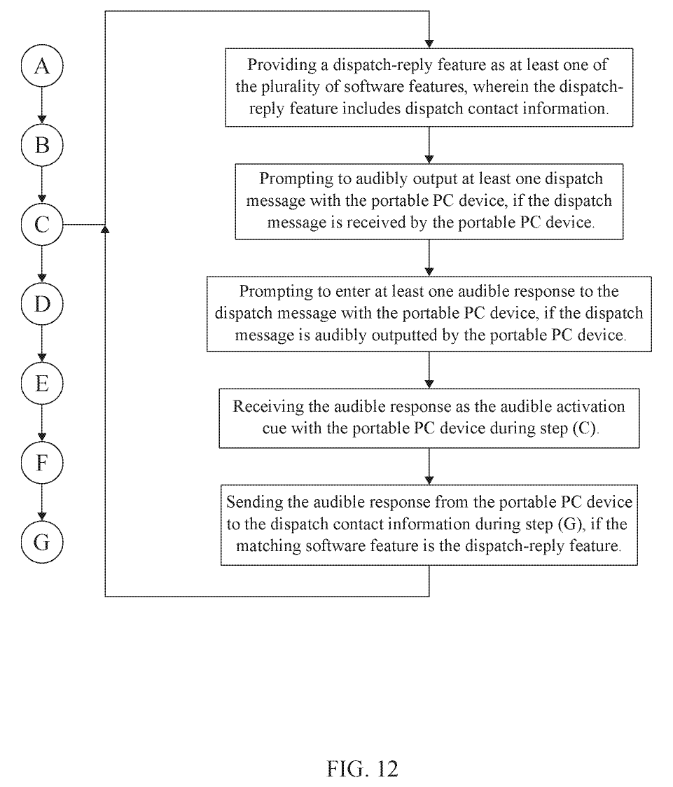

The system of the preset invention also allows the driver to receive messages from specific users, such as from dispatch. As can be seen in FIGS. 1 and 2, the system of the present invention may further include a dispatch-reply feature as at least one feature of the plurality of software features. Like the driver-messaging feature, the dispatch-reply feature also utilizes the dispatch contact information to receive messages from dispatch. As can be seen in FIG. 12, the subprocess of outputting a dispatch message to the driver includes the steps of prompting to audibly output at least one dispatch message with the portable PC device, if the dispatch message is received by the portable PC device. The portable PC device preferably notifies the driver of a message and can ask the driver, “A message has arrived, would you like to hear it?” The dispatch-reply feature allows the driver to receive different types of messages from dispatch. For example, the dispatch message can be a fleetwide message that is broadcasted to the portable computing device. The dispatch message can also be a direct message to the driver that is unicasted to the portable computing device.

As can be seen in FIG. 12, once the portable PC device outputs the dispatch message, the driver can be asked to submit a reply. So, the driver is prompted to enter at least one audible response to the dispatch message with the portable PC device, if the dispatch message is audibly outputted by the portable PC device. For example, the driver can be asked, “do you want to respond to the message now?” Then, the audible response is received as the audible activation cue with the portable PC device during Step C. In other words, once the driver confirms that the driver wants to respond, the portable PC device actively listens to the response until the response is received and recorded. Finally, the audible response is sent from the portable PC device to the dispatch contact information during Step G, if the matching software feature is the dispatch-reply feature. Thus, the driver and dispatch can communicate without the driver having to manually interact with the portable PC device while driving.

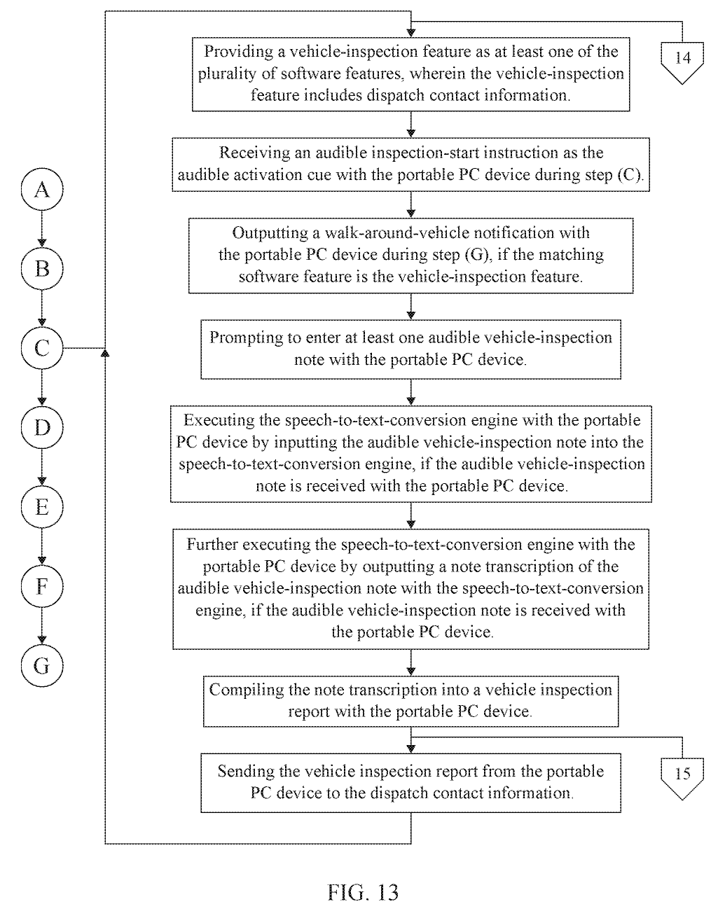

In addition to assisting the driver during the trip, the system of the present invention can assist the driver with other tasks prior or after the trip. For example, the system can assist the driver with preparing a Driver Vehicle Inspection Report (DVIR) before or after the trip. As can be seen in FIGS. 1 and 2, the system may further include a vehicle-inspection feature as at least one feature of the plurality of software features. In addition, the vehicle-inspection feature also utilizes the dispatch contact information to send the finalized report to dispatch as necessary. As can be seen in FIG. 13, the subprocess of assisting the preparation of a DVIR before or after a trip includes the steps of receiving an audible inspection-start instruction as the audible activation cue with the portable PC device during Step C. For example, the driver can say, “Charlie, begin DVIR pre-trip inspection,” and the system can start the subprocess. Then, a walk-around-vehicle notification is output with the portable PC device during Step G, if the matching software feature is the vehicle-inspection feature. For example, the portable PC device can output, “Charlie confirms, please use 30 minutes for your pre-trip… always be safe.” This way, the driver can be sure of when to start inspecting the corresponding vehicle.

As can be seen in FIG. 13, once the driver starts the vehicle inspection, the driver is prompted to enter at least one audible vehicle-inspection note with the portable PC device. For example, the driver can say, “Charlie add driver side headlamp cracked,” and the portable PC device can make note of the audible vehicle-inspection not. Then, the speech-to-text-conversion engine is executed with the portable PC device by inputting the audible vehicle-inspection note into the speech-to-text-conversion engine, if the audible vehicle-inspection note is received with the portable PC device. This way, the audible vehicle-inspection note can be processed to extract the content of the note.

As can be seen in FIG. 13, the speech-to-text-conversion engine is further executed with the portable PC device by outputting a note transcription of the audible vehicle-inspection note with the speech-to-text-conversion engine, if the audible vehicle-inspection note is received with the portable PC device. The note transcription contains all the information necessary to prepare the DVIR, such as details of the vehicle damage and other information provided by the driver. Once the note transcription is generated, the note transcription is compiled into a vehicle inspection report with the portable PC device. The vehicle inspection report can be formatted using a predetermined template to meet the requirements established by the company. Furthermore, the vehicle inspection report is sent from the portable PC device to the dispatch contact information so that the company can store that information.

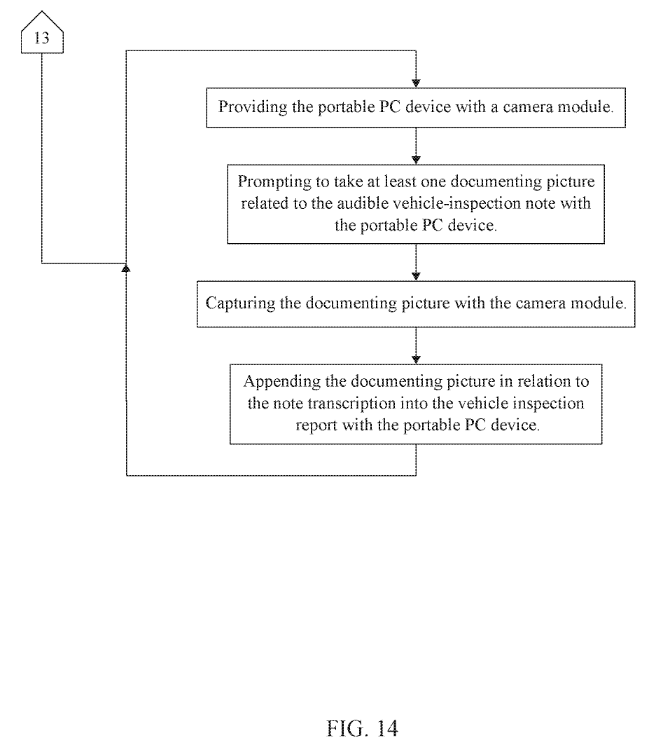

The system of the present invention can also enable the attachment of pictures and/or videos to the vehicle-inspection note. As can be seen in FIGS. 1 and 2, the portable PC device can include a camera module that facilitates the capture of the pictures and/or videos for the vehicle-inspection note. The camera module can be an integral part of the portable PC device or a peripheral that can be connected to the portable PC device. As can be seen in FIG. 14, the subprocess of attaching a picture or video to the vehicle-inspection note includes the steps of prompting the driver to take at least one documenting picture related to the audible vehicle-inspection note with the portable PC device. For example, after detailing the information for the vehicle-inspection note, the portable PC device can output, “would you like to take a photo?” Once the driver confirms so, the documenting picture or video is captured with the camera module. The driver may be asked to confirm the captured picture or video to ensure that the damage is properly documented. Finally, the documenting picture in relation to the note transcription is appended into the vehicle inspection report with the portable PC device.

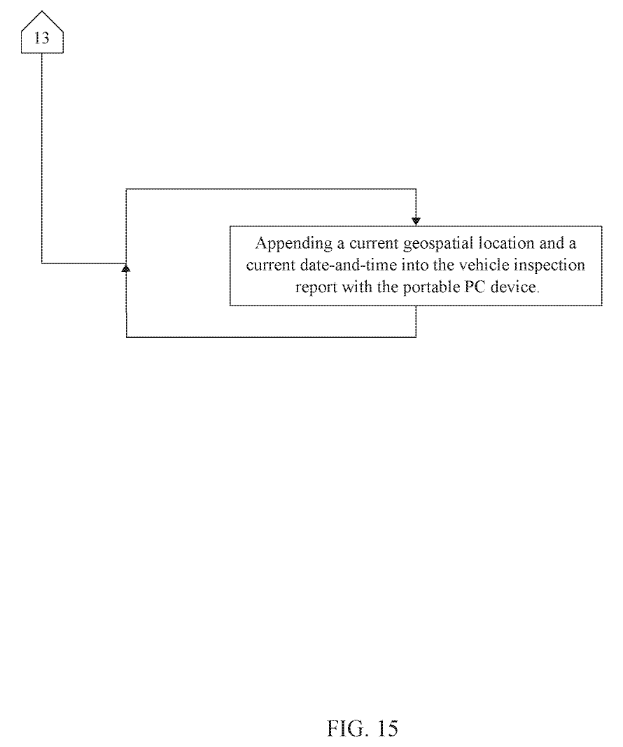

In some embodiments, the system of the present invention can be configured with means to certify the accuracy and legitimacy of the DVIR. For example, the system can append the time and location of where the DVIR is generated for auditing purposes. As can be seen in FIG. 15, the subprocess of adding the current time and location to the DVIR includes the step of appending a current geospatial location and a current date-and-time into the vehicle inspection report with the portable PC device. This way, the system can record where the DVIR is prepared for record keeping by the company. In other embodiments, additional mechanisms can be utilized to further legitimize the prepared DVIR.

Depending on the type of device the portable PC device is, the driver may not be able to move the portable PC device out of the vehicle’s cabin to perform the vehicle inspection. The system of the present invention can enable the driver to utilize a secondary device to perform the vehicle inspection. As can be seen in FIGS. 1 and 2, the system may further include a mobile PC device that is communicably coupled to the portable PC device. For example, the mobile PC device can be the driver’s smartphone or other portable computing device that allows the driver to perform the same tasks as with the portable PC device. In addition, the mobile PC device is paired to the portable PC device to enable the transmission of data from the mobile PC device to the portable PC device. This way, the driver can utilize the mobile PC device to capture the necessary information which is then relayed to the portable PC device to generate the vehicle inspection report.

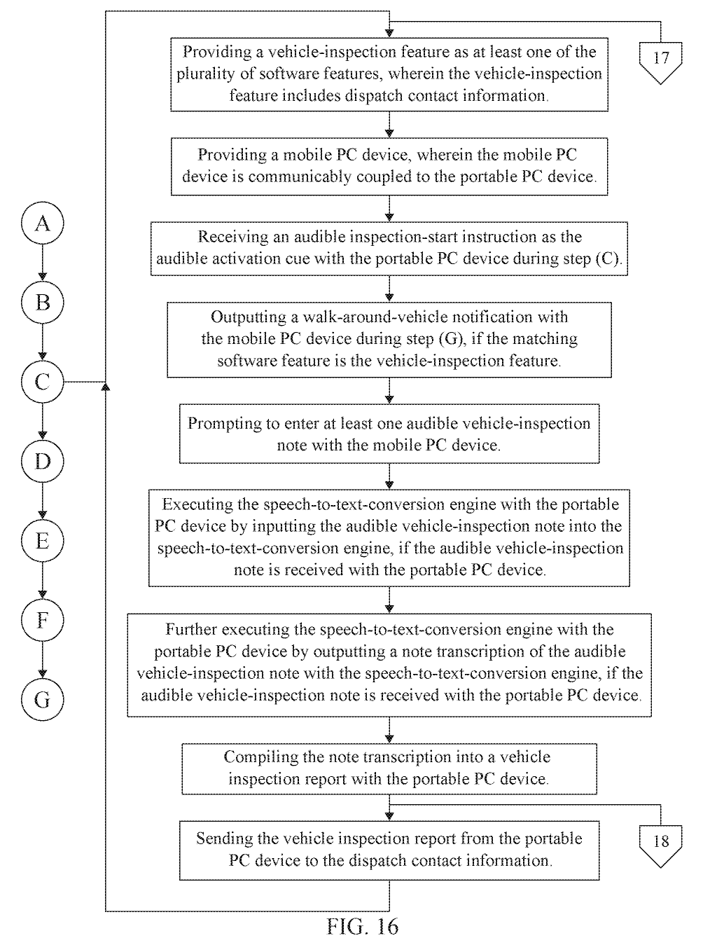

As can be seen in FIG. 16, the subprocess of performing the vehicle inspection using the mobile PC device includes the steps of receiving an audible inspection-start instruction as the audible activation cue with the portable PC device during Step C. Like before, the driver audibly commands the vehicle inspection to start using the portable PC device. The driver may also start the subprocess from the mobile PC device. Then, a walk-around-vehicle notification is output with the mobile PC device during Step G, if the matching software feature is the vehicle-inspection feature. This signals the driver to start the vehicle inspection with the mobile PC device. Further, the driver is prompted to enter at least one audible vehicle-inspection note with the mobile PC device. This way, the driver can enter the vehicle-inspection note from the mobile PC device instead of using the portable PC device.

As can be seen in FIG. 16, the speech-to-text-conversion engine is further executed with the portable PC device by inputting the audible vehicle-inspection note into the speech-to-text-conversion engine, if the audible vehicle-inspection note is received with the portable PC device. Since the mobile PC device is paired with the portable PC device, the vehicle-inspection note is relayed to the portable PC device for processing. Then, the speech-to-text-conversion engine is executed with the portable PC device by outputting a note transcription of the audible vehicle-inspection note with the speech-to-text-conversion engine, if the audible vehicle-inspection note is received with the portable PC device. This generates the machine-readable version of the vehicle-inspection note described above. Moreover, the note transcription is compiled into a vehicle inspection report with the portable PC device, and the vehicle inspection report is sent from the portable PC device to the dispatch contact information. Thus, the vehicle inspection is performed using the mobile PC device.

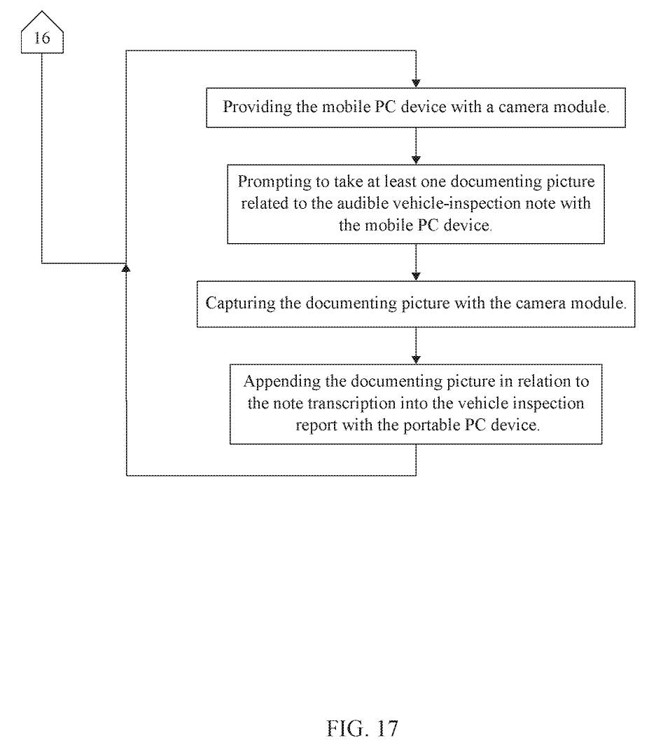

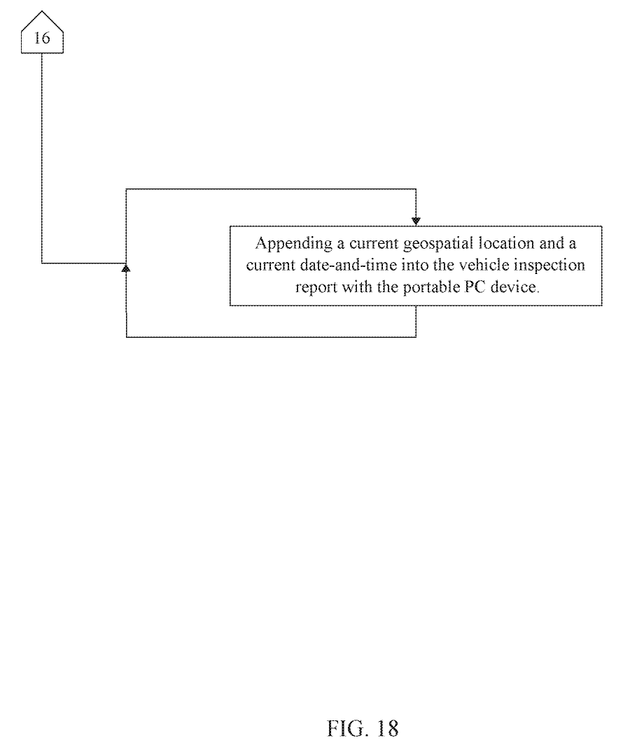

Likewise, the driver can append pictures or videos of the vehicle inspection to the DVIR with the mobile PC device. As can be seen in FIGS. 1 and 2, the mobile PC device includes a camera module which can be used to capture the pictures or videos of the vehicle inspection. As can be seen in FIGS. 17 and 18, the subprocess of appending a picture or video to the vehicle inspection report using the mobile PC device includes the steps of prompting to take at least one documenting picture related to the audible vehicle-inspection note with the mobile PC device. This gives the option of appending the picture or video to the vehicle-inspection note using the mobile PC device if the driver desires to do so. Then, the documenting picture is captured with the camera module and relayed to the portable PC device for further processing. The documenting picture in relation to the note transcription can then be appended into the vehicle inspection report with the portable PC device. Furthermore, a current geospatial location and a current date-and-time can be appended into the vehicle inspection report with the portable PC device as before. In other embodiments, the system may accommodate other devices that facilitate the vehicle inspection and other tasks that the driver has to perform before, during, or after the trip.

Although the invention has been explained in relation to its preferred embodiment, it is to be understood that many other possible modifications and variations can be made without departing from the spirit and scope of the invention.

What is claimed is:

1. A method of audibly assisting a driver of a commercial vehicle, the method including the steps of:
(A) providing at least one driver-assisting software managed between at least one remote server and a portable personal computing (PC) device, wherein the remote server and the portable PC device are communicably coupled to each other, and wherein the driver-assisting software includes a plurality of software features, and wherein each software feature includes a textual activation cue;
(B) providing a speech-to-text-conversion engine managed by the portable PC device;
(C) receiving at least one audible activation cue with the portable PC device;
(D) executing the speech-to-text-conversion engine with the portable PC device by inputting the audible activation cue into the speech-to-text-conversion engine;
(E) further executing the speech-to-text-conversion engine with the portable PC device by outputting a cue transcription of the audible activation cue with the speech-to-text-conversion engine;
(F) comparing the cue transcription to the textual activation cue of each software feature with the portable PC device in order to identify at least one matching software feature from the plurality of software features, wherein the cue transcription matches the textual activation cue of the matching software feature; and
(G) executing the matching software feature with the portable PC device, if the matching software feature is identified amongst the plurality of software features.

2. The method as claimed in claim 1, wherein the portable computing device is an electronic logging device (ELD).

3. The method as claimed in claim 1 further comprising the steps of:
providing a driver-login feature as at least one of the plurality of software features, wherein the driver-login feature includes a driver voiceprint;
comparing the audible activation cue to the driver voiceprint with the portable PC device after step (F) in order to verify the audible activation cue with the driver voiceprint, if the matching software feature is the driver-login feature; and
logging into the driver-assisting software with the portable PC device during step (G), if the audible activation cue is verified with the driver voiceprint.

4. The method as claimed in claim 3 further comprising the steps of:
providing the driver-login feature with driver-identification information;
prompting to enter at least one audible credential with the portable PC device, if the audible activation cue is verified by the driver voiceprint;
executing the speech-to-text-conversion engine with the portable PC device by inputting the audible credential into the speech-to-text-conversion engine, if the audible credential is received with the portable PC device;
further executing the speech-to-text-conversion engine with the portable PC device by outputting a credential transcription of the audible credential with the speech-to-text-conversion engine, if the audible credential is received with the portable PC device;
comparing the credential transcription to the driver-identification information with the portable PC device in order to verify the credential transcription with the driver-identification information; and
logging into the driver-assisting software with the portable PC device during step (G), if the audible activation cue is verified with the driver voiceprint, and if the credential transcription is verified with the driver-identification information.

5. The method as claimed in claim 1 further comprising the steps of:
providing a driver-logout feature as at least one of the plurality of software features, wherein the driver-logout feature includes a driver voiceprint;
comparing the audible activation cue to the driver voiceprint with the portable PC device after step (F) in order to verify the audible activation cue with the driver voiceprint, if the matching software feature is the driver-logout feature; and
logging out of the driver-assisting software with the portable PC device during step (G), if the audible activation cue is verified with the driver voiceprint.

6. The method as claimed in claim 5 further comprising the steps of:
providing the driver-logout feature with driver-identification information;
prompting to enter at least one audible credential with the portable PC device, if the audible activation cue is verified by the driver voiceprint;
executing the speech-to-text-conversion engine with the portable PC device by inputting the audible credential into the speech-to-text-conversion engine, if the audible credential is received with the portable PC device;
further executing the speech-to-text-conversion engine with the portable PC device by outputting a credential transcription of the audible credential with the speech-to-text-conversion engine, if the audible credential is received with the portable PC device;
comparing the credential transcription to the driver-identification information with the portable PC device in order to verify the credential transcription with the driver-identification information; and
logging out the driver-assisting software with the portable PC device during step (G), if the audible activation cue is verified with the driver voiceprint, and if the credential transcription is verified with the driver-identification information.

7. The method as claimed in claim 1 further comprising the steps of:
providing a service-hours-inquiring feature as at least one of the plurality of software features;
tracking a current total for drive time with the portable PC device, wherein the current total for drive time is measured between a driver login and a current time of the driver-assisting software;
receiving an audible inquiry for drive time as the audible activation cue with the portable PC device during step (C); and
audibly outputting the current total for drive time with the portable PC device during step (G), if the matching software feature is the service-hours-inquiring feature.

8. The method as claimed in claim 7 further comprising the steps of:
providing the service-hours-inquiring feature with a maximum threshold for drive time; and
further audibly outputting a difference between the maximum threshold for drive time and the current total for drive time with the portable PC device during step (G), if the matching software feature is the service-hours-inquiring feature.

9. The method as claimed in claim 1 further comprising the steps of:
providing a driver-messaging feature as at least one of the plurality of software features;
contextually parsing through the cue transcription for at least one message-recipient contact with the portable PC device after step (F), if the matching software feature is the driver-messaging feature;
prompting to enter at least one audible message for the message-recipient contact with the portable PC device;
prompting to enter an audible confirmation to send the audible message to the message-recipient contact with the portable PC device, if the audible message is entered into the portable PC device;
executing the speech-to-text-conversion engine with the portable PC device by inputting the audible message into the speech-to-text-conversion engine, if the audible confirmation is received with the portable PC device;
further executing the speech-to-text-conversion engine with the portable PC device by outputting a message transcription of the audible message with the speech-to-text-conversion engine, if the audible confirmation is received with the portable PC device; and
sending the message transcription from the portable PC device to the message-recipient contact during step (G).

10. The method as claimed in claim 9 further comprising the steps of:
prompting to select an urgency level for the audible message with the portable PC device, if the audible message is entered into the portable PC device; and
appending the urgency level into the message transcription with the portable PC device, if the urgency level is selected with the portable PC device.

11. The method as claimed in claim 9, wherein the message-recipient contact is dispatch contact information.

12. The method as claimed in claim 1 further comprising the steps of:
providing a dispatch-reply feature as at least one of the plurality of software features, wherein the dispatch-reply feature includes dispatch contact information;
prompting to audibly output at least one dispatch message with the portable PC device, if the dispatch message is received by the portable PC device;
prompting to enter at least one audible response to the dispatch message with the portable PC device, if the dispatch message is audibly outputted by the portable PC device;
receiving the audible response as the audible activation cue with the portable PC device during step (C); and
sending the audible response from the portable PC device to the dispatch contact information during step (G), if the matching software feature is the dispatch-reply feature.

13. The method as claimed in claim 12, wherein the dispatch message is broadcasted to the portable computing device.

14. The method as claimed in claim 12, wherein the dispatch message is unicasted to the portable computing device.

15. The method as claimed in claim 1 further comprising the steps of:
providing a vehicle-inspection feature as at least one of the plurality of software features, wherein the vehicle-inspection feature includes dispatch contact information;
receiving an audible inspection-start instruction as the audible activation cue with the portable PC device during step (C);
outputting a walk-around-vehicle notification with the portable PC device during step (G), if the matching software feature is the vehicle-inspection feature;
prompting to enter at least one audible vehicle-inspection note with the portable PC device;
executing the speech-to-text-conversion engine with the portable PC device by inputting the audible vehicle-inspection note into the speech-to-text-conversion engine, if the audible vehicle-inspection note is received with the portable PC device;
further executing the speech-to-text-conversion engine with the portable PC device by outputting a note transcription of the audible vehicle-inspection note with the speech-to-text-conversion engine, if the audible vehicle-inspection note is received with the portable PC device;
compiling the note transcription into a vehicle inspection report with the portable PC device; and
sending the vehicle inspection report from the portable PC device to the dispatch contact information.

16. The method as claimed in claim 15 further comprising the steps of:
providing the portable PC device with a camera module;
prompting to take at least one documenting picture related to the audible vehicle-inspection note with the portable PC device;
capturing the documenting picture with the camera module; and
appending the documenting picture in relation to the note transcription into the vehicle inspection report with the portable PC device.

17. The method as claimed in claim 15 further comprising the step of:
appending a current geospatial location and a current date-and-time into the vehicle inspection report with the portable PC device.

18. The method as claimed in claim 1 further comprising the steps of:
providing a vehicle-inspection feature as at least one of the plurality of software features, wherein the vehicle-inspection feature includes dispatch contact information;
providing a mobile PC device, wherein the mobile PC device is communicably coupled to the portable PC device;
receiving an audible inspection-start instruction as the audible activation cue with the portable PC device during step (C);
outputting a walk-around-vehicle notification with the mobile PC device during step (G), if the matching software feature is the vehicle-inspection feature;
prompting to enter at least one audible vehicle-inspection note with the mobile PC device;
executing the speech-to-text-conversion engine with the portable PC device by inputting the audible vehicle-inspection note into the speech-to-text-conversion engine, if the audible vehicle-inspection note is received with the portable PC device;
further executing the speech-to-text-conversion engine with the portable PC device by outputting a note transcription of the audible vehicle-inspection note with the speech-to-text-conversion engine, if the audible vehicle-inspection note is received with the portable PC device;
compiling the note transcription into a vehicle inspection report with the portable PC device; and
sending the vehicle inspection report from the portable PC device to the dispatch contact information.

19. The method as claimed in claim 18 further comprising the steps of:
providing the mobile PC device with a camera module;
prompting to take at least one documenting picture related to the audible vehicle-inspection note with the mobile PC device;
capturing the documenting picture with the camera module; and
appending the documenting picture in relation to the note transcription into the vehicle inspection report with the portable PC device.

20. The method as claimed in claim 18 further comprising the step of:
appending a current geospatial location and a current date-and-time into the vehicle inspection report with the portable PC device.
